(19) United States
(12) Patent Application Publication
(10) Pub. No.: US 2006/0269828 A1
(43) Pub. Date: Nov. 30, 2006

(54) Fuel cell

(76) Inventors: Akira Tanaka, Mito (JP); Hidetoshi Honbou, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/437,704

(22) Filed: May 22, 2006

(30) Foreign Application Priority Data
May 24, 2005 (JP) 2005-150642

(51) Int. Cl. H01M 4/94; H01M 8/10; H01M 2/08

(52) U.S. Cl. 429/44; 429/30; 429/35

(57) ABSTRACT

It is an object of the present invention to provide a fuel cell equipped with a membrane electrode assembly which can relax stress concentration at a catalyst layer end to prevent an electrolyte membrane damage and have high reliability. The membrane electrode assembly comprises an electrolyte membrane coated with an anode catalyst layer and anode diffusion layer on one side and with a cathode catalyst layer and cathode diffusion layer on the other side, wherein the anode and cathode catalyst layers have the same or essentially the same area and are set out at the same or essentially the same positions across the electrolyte membrane, and at least one of the anode and cathode diffusion layers is out of alignment, at least at one end, with the corresponding electrode catalyst layer to relax stress concentration at a catalyst layer end and prevent an electrolyte membrane damage.

### FIELD OF THE INVENTION

The present invention relates to a fuel cell equipped with a membrane electrode assembly, more particularly a fuel cell suitable for compact, portable power sources fueled by a liquid fuel, e.g., methanol.

### BACKGROUND OF THE INVENTION

Use of a membrane electrode assembly (MEA), in which a polymer electrolyte and catalyst electrode are integrated, has been studied for direct fuel cells fueled by a liquid fuel, e.g., direct methanol fuel cell (DMFC). Fuel cells of this type may involve problems resulting from stress concentration in outer periphery ends of a catalyst layer provided on each side of an electrolyte membrane to put an excessive stress on these portions, as the membrane becomes increasingly thinner. As one of the measures against these problems, Patent Document 1 proposes to cover an electrolyte membrane with a diffusion layer on each side in such a way that one diffusion layer protrudes beyond the other diffusion layer, and one catalyst layer is positioned out of alignment with the other catalyst layer.

(Patent Document 1) JP-A-2003-68323

### BRIEF SUMMARY OF THE INVENTION

A wider catalyst layer is more preferable for power generation efficiency, because it provides a wider area for the catalytic reactions. It is therefore preferable to have an anode and cathode catalyst layers as close to each other in area as possible and to set out them at positions as close to each other as possible across an electrolyte membrane. At the same time, when an electrolyte membrane is coated with a catalyst on one side and then with a catalyst on the other side, it is preferable to align the catalyst layer ends with each other, because these layers are provided on a given area. Moreover, when an anode diffusion layer is clearly different in area from a cathode diffusion layer, the bimetallic effect will result to cause warpage or swelling of the MEA, making it difficult to mount the MEA in a cell power source.

It is an object of the present invention to provide a fuel cell which can relax stress concentration at a catalyst layer end in a membrane electrode assembly.

The present invention provides a fuel cell equipped with a membrane electrode assembly which has an anode and cathode catalyst layers of the same or essentially the same area, set out at the same or essentially the same positions across an electrolyte membrane for the assembly in such a way that at least one of an anode and cathode diffusion layers protrudes at least at one end beyond the corresponding electrode catalyst layer.

The present invention also provides a fuel cell equipped with a membrane electrode assembly (MEA) with a gasket on the outer side of the MEA for tightly sealing a gas supplied as a fuel or oxidant, wherein the MEA is structurally designed similarly to the above.

The present invention can relax stress concentration at catalyst layer ends in a membrane electrode assembly to provide a fuel cell of improved reliability.

Other objects, features and advantages of the invention will become apparent from the following description of the embodiments of the invention taken in conjunction with the accompanying drawings.

### BRIEF DESCRIPTION OF THE DRAWINGS

FIG. 1 is an oblique view illustrating one embodiment of membrane electrode assembly for the fuel cell of the present invention.

FIG. 2 is a plan view illustrating another embodiment of membrane electrode assembly.

FIG. 3 is a cross-sectional and plan views illustrating still another embodiment of membrane electrode assembly for the present invention.

FIG. 4 is an oblique view illustrating still another embodiment of membrane electrode assembly.

FIG. 5 is a cross-sectional and plan views illustrating still another embodiment of membrane electrode assembly with a plurality of catalyst layers and diffusion layers on each side of an electrolyte membrane.

FIG. 6 is a cross-sectional view illustrating an embodiment of fuel cell of the present invention.

### DESCRIPTION OF REFERENCE NUMERALS

1: Electrolyte membrane, 2: Cathode, 3: Anode, 4: membrane electrode assembly, 5: Protective adhesive layer for catalyst layer, 21: Cathode catalyst layer, 22: Cathode diffusion layer, 23: Cathode side gasket, 24: Cathode side power collector plate, 25: Cathode side air hole, 31: Anode catalyst layer, 32: Anode diffusion layer, 33: Anode side gasket, 34: Anode side power collector plate, 35: Anode side air hole

### DETAILED DESCRIPTION OF THE INVENTION

Fuel cells have various advantages, e.g., high energy efficiency because they directly produce electric energy electrochemically from a fuel, and environmentally friendliness because the effluent is mainly composed of water. Therefore, attempts have been made to apply them to various devices, e.g., vehicles, dispersed power sources and information electronic devices. A fuel cell is equipped with at least a solid or liquid electrolyte, and two electrodes, anode and cathode, to induce desired electrochemical reactions. It is a power generating device which directly converts chemical energy of a fuel into electrical energy at a high efficiency. Fuels for fuel cells include hydrogen produced by chemical conversion of a fossil fuel or water; methanol, alkali halides and hydrazine, which are normally in the form of liquid or solution; and dimethyl ether as a liquefied gas under pressure. Oxidant gases for cells are air or oxygen gas.

A fuel is electrochemically oxidized on the anode and oxygen is reduced on the cathode to produce an electric potential difference between these electrodes. When a load as an external circuit is placed between the electrodes, the ions migrate in the electrolyte to produce electric power in the electrolyte. Therefore, fuel cells are highly expected to go into large-size systems as alternatives for thermal generators, compact, dispersed type cogeneration systems, and power sources for electric vehicles as alternatives for engine-driven power generators.

Of various types of fuel cells, those attracting attention are direct methanol fuel cells (DMFCs), and metal halide and hydrazine fuel cells as compact, portable power sources, because of high volumetric energy density of the fuel they use. Of all others, DMFCs will provide ideal power source systems, because they are easily handled and use methanol, which is expected to be produced from biomasses in the near future.

The present invention can set out an anode catalyst layer and anode diffusion layer of the same or essentially the same size while partly displacing them from each other. Similarly, it can set out a cathode catalyst layer and cathode diffusion layer of the same or essentially the same size while partly displacing them from each other.

Moreover, it can set out an anode catalyst layer and anode diffusion layer which is larger than the anode catalyst layer, protruding the latter end beyond the former. Similarly, it can set out a cathode catalyst layer and cathode diffusion layer which is larger than the cathode catalyst layer, protruding the latter end beyond the former. In these cases, the protruded length is preferably kept at 100 to 300 μm, inclusive.

Conversely, it can set out a cathode diffusion layer inside of a cathode catalyst layer which is larger than the cathode diffusion layer in such a way not to protrude the former beyond the latter. The anode side can have a similar structure. In these cases, it is preferable to keep the cathode diffusion layer end apart from the cathode catalyst layer end, and the anode diffusion layer end apart from the anode catalyst layer end by 100 to 300 μm, inclusive.

In a preferred embodiment of the present invention, an anode diffusion layer is set out inside of an anode catalyst layer, and a cathode diffusion layer inside of a cathode catalyst layer. In another preferred embodiment, an anode and cathode diffusion layer ends partly protrude beyond a respective anode and cathode catalyst layer ends.

A cathode diffusion layer may be laid on a rectangular cathode catalyst layer of essentially the same size. In this case, the cathode diffusion layer corners are cut off to expose part of the cathode catalyst layer. The anode side can have a similar structure.

In a structure with anode or cathode diffusion layer partly protruding beyond an anode or cathode catalyst layer, it is preferable to provide an adhesive protective layer between the protruded portion and electrolyte membrane to protect the catalyst layer end. The protective layer may be made of a material having the same composition as a binder used for producing a membrane electrode assembly, epoxy resin, hydrocarbon-based resin, silicone-based resin or UV-curable resin.

The expression “essentially the same” used in this specification reflects difficulty of securing exactly the same size or shape because of errors or the like involved in manufacture of the related members.

Embodiments of the present invention are described in detail by referring to the attached drawings.

### EXAMPLE 1

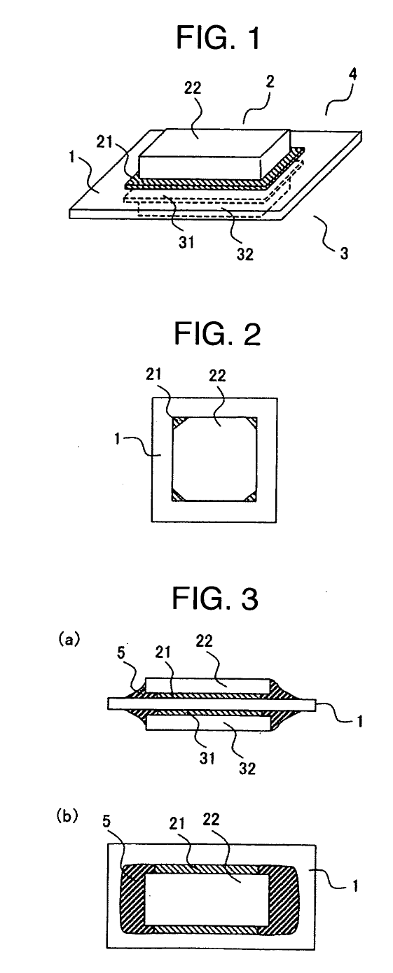

FIG. 1 is an oblique view illustrating one embodiment of membrane/electrode assembly for the fuel cell of the present invention. The membrane/electrode assembly 4 comprises the cathode 2, anode 3 and electrolyte membrane 1. A stable fuel cell unaffected by carbon dioxide gas in air can be realized when the electrolyte membrane 1 is made of a proton-conductive material. The materials useful for the electrolyte membrane include sulfonated fluoro polymers represented by polyperfluoro styrene sulfonic acid and polyperfluoro hydrocarbon sulfonic acid; sulfonated hydrocarbon polymers, e.g., polystyrene sulfonic acid, sulfonated polyether sulfone and sulfonated polyetherketone; and sulfoalkylated hydrocarbon polymers. A fuel cell with the electrolyte membrane of the above material can generally work at 80° C. or lower. The electrolyte membrane may be also of a composite material with a proton-conductive inorganic material (e.g., tungsten, zirconium or tin oxide hydrate) microscopically dispersed in a heat-resistant resin or sulfonated resin. A fuel cell with the above electrolyte membrane can work at higher temperature.

The anode 3 comprises the anode catalyst layer 31 and anode diffusion layer 32. The anode catalyst layer is normally 20 to 400 μm thick. The anode catalyst layer 31 can comprise fine particles of platinum and ruthenium or platinum/ruthenium alloy as a catalyst supported by a carrier of carbonaceous particles. The cathode 2 comprises the cathode catalyst layer 21 and cathode diffusion layer 22. The cathode catalyst layer 21 can comprise fine particles of platinum as a catalyst supported by a carrier of carbonaceous particles. The cathode catalyst layer is normally 20 to 400 μm thick.

Platinum as the major catalyst component is incorporated generally at 50% by mass or less in the carbonaceous particles. The electrode can have a high performance even at a platinum content of 30% by mass or less when the catalyst is highly active or its dispersion in the carbonaceous carrier is improved. Platinum is incorporated preferably at 0.5 to 5 mg/cm² in the anode catalyst layer 31 and 0.1 to 2 mg/cm² in the cathode catalyst layer 21.

In Example 1, sulfoalkylated polyether sulfone was used for the electrolyte membrane 1. The anode catalyst layer 31 was composed of a catalyst of platinum and ruthenium (atomic ratio: 50/50) supported by a carrier of carbonaceous particles (XC72R, Cabot) with platinum incorporated at 30% by mass on the carrier. A binder for the anode catalyst layer 31 was a similar polymer of sulfoalkylated polyether sulfone to that for the electrolyte membrane, although sulfonated to a lesser equivalent. Use of such a binder keeps crossovers of water and methanol in the electrolyte dispersed in the electrode catalyst larger than those in the electrolyte membrane, thereby accelerating fuel diffusion onto the electrode catalyst and hence improving performance of the electrode.

The cathode diffusion layer 22 is a laminate of water-repellant layer and porous carbon board, the former in contact with the cathode catalyst layer. The water-repellant layer improves water repellency to increase steam pressure around the cathode, and thereby to prevent diffusion/discharge of produced steam and coalescence of water droplets. The board is preferably of an electroconductive, porous material, and can be of a woven or non-woven fabric of carbon fibers. Carbon cloth and carbon paper are examples of woven fabrics of carbon fibers.

The anode diffusion layer 32 can be of a woven or non-woven fabric of carbon fibers which simultaneously satisfies electroconductivity and porosity. Carbon cloth and carbon paper are examples of woven fabrics of carbon fibers. The anode diffusion layer 32 works to supply an aqueous solution fuel and swiftly discharge carbon dioxide gas produced. Therefore, the carbonaceous, porous board is preferably oxidized or irradiated with UV to make the surface hydrophilic, dispersed with a hydrophilic resin, or impregnated with a highly hydrophilic material, represented by titanium oxide. The above treatment prevents carbon dioxide gas produced on the anode from growing bubbles in the anode diffusion layer and thereby improves output density of the fuel cell. The anode diffusion layer may be of another material, e.g., non-woven fabric of stainless steel fibers, or porous material of titanium or tantalum. In Example 1, carbon cloth was used.

The cathode catalyst layer 21 protrudes beyond the cathode diffusion layer 22 with the ends of these layers being out of alignment with each other, and the anode catalyst layer 31 protrudes beyond the anode diffusion layer 32 with the ends of these layers being out of alignment with each other. This structure prevents the cathode catalyst layer 21 end from being directly exposed to a stress, produced at the cathode diffusion layer 22 or electrolyte membrane 1 end by the expansion/shrinkage-caused deformation, thereby relaxing stress concentration there and preventing a damage of the electrolyte membrane originating from the vicinity of the cathode catalyst layer 21 end. Similarly, a damage of the electrolyte membrane originating from the vicinity of the anode catalyst layer 21 end is prevented.

The MEA shown in FIG. 1 has the cathode catalyst layer 21 and anode catalyst layer 22 are set out at the same positions across the electrolyte membrane 1. In other words, they are set out at the same position, when projected, and have essentially the same projected area. As a result, the protons produced on the anode catalyst layer 31 take the shortest way to move towards the cathode catalyst layer 21, preventing power generation performance loss. The MEA structure with the cathode catalyst layer 21 and anode catalyst layer 22 having essentially the same area and being set out at essentially the same projected position prevents loss of the catalytic reaction efficiency and damage of the electrolyte membrane resulting from combustion of an aqueous methanol solution on the cathode catalyst layer 21 after it runs through the electrolyte membrane.

Each of the cathode and anode catalyst layers shown in FIG. 1 is 100 μm thick and protrudes from the respective diffusion layer by 200 μm. In Example 1, the same thickness was adopted for the cathode and anode catalyst layers. They may differ from each other in thickness, because an optimum thickness is determined depending on a combination with electrolyte membrane performance or the like. The diffusion layer is preferably larger than the catalyst layer for reducing current resistance.

### EXAMPLE 2

It is possible to protrude the catalyst layer from the diffusion layer only by the corners, where a stress is concentrated, as shown in FIG. 2. This structure also brings an effect of preventing reliability loss resulting from stress concentration. In the MEA shown in FIG. 2, the diffusion layer is laid on the rectangular cathode catalyst layer of essentially the same size, with the corners of the diffusion layer cut off. A similar effect can be brought, when each corner of the diffusion layer is designed to have a larger diameter than that of the catalyst layer.

### EXAMPLE 3

FIG. 3 illustrates an MEA structure which is advantageous for reducing current resistance. FIG. 3 (a) is a cross-sectional view and (b) is a plan view. It is preferable to have a diffusion layer larger than a catalyst layer for reducing current resistance. However, this may cause stress concentration and a damage of the catalyst layer originating from the corner. Example 3 protruded the cathode and anode diffusion layers beyond the respective cathode and anode catalyst layers, and provided the adhesive protective layer 5 between the protruded portion and electrolyte membrane to protect the end of each of the catalyst layers. This structure can prevent a damage originating from the anode or cathode catalyst layer end. The adhesive layer for protecting the catalyst layer was provided using a binder having the same composition as that used for providing the catalyst layer. It is not necessary for the binder to have the same composition as that for the catalyst layer, so long as it has a methanol resistance and methanol shielding capacity, and a glass transition temperature equivalent to or higher than fuel cell operating temperature (about 100° C. or lower). The adhesive layer may be of an epoxy-based resin, hydrocarbon-based resin, UV-curable resin or the like. It preferably has a cross-sectional shape becoming thinner towards the periphery for relaxation of stress concentration.

### EXAMPLE 4

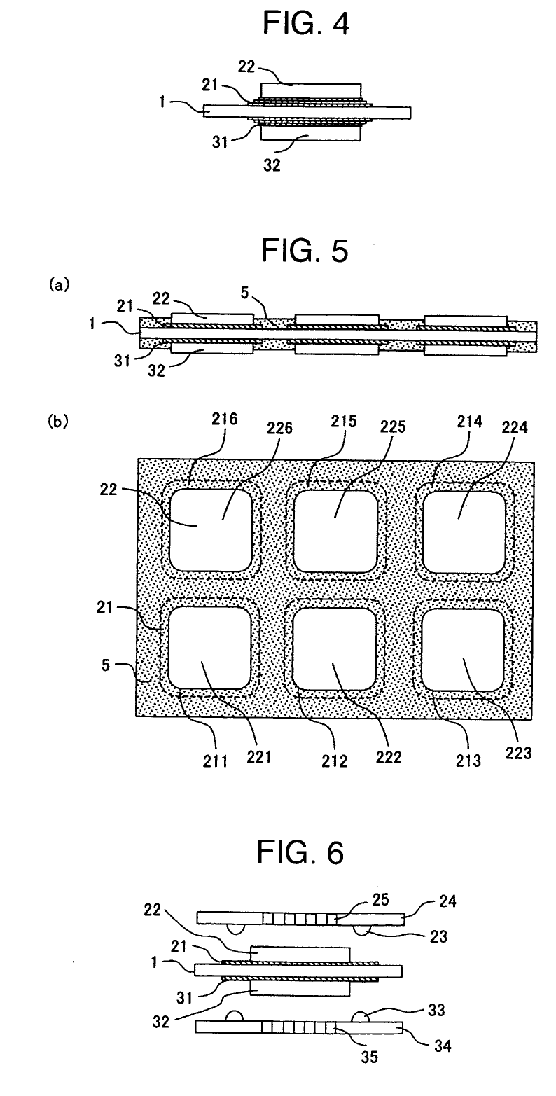

FIG. 4 illustrates still another embodiment of the MEA, comprising the cathode catalyst layer 21 and anode catalyst layer 31, each of 3-layer laminate structure becoming narrower towards the top. Each layer is coated with the cathode diffusion layer 22 or anode diffusion layer 32 having the same area as the uppermost laminate layer. This structure allows the catalyst layer to protrude beyond the diffusion layer, and the catalyst layer to become thinner towards the periphery, thereby relaxing stress concentration at the catalyst layer end and preventing damage of the electrolyte membrane.

### EXAMPLE 5

FIG. 5 illustrates still another embodiment of the MEA, comprising a plurality of catalyst layers and diffusion layers on each side of an electrolyte membrane, where (a) is a cross-sectional view and (b) is a plan view on the cathode side. Each of the cathode diffusion layers 221 to 226 has a larger area than each of the anode diffusion layers 211 to 216. The adhesive layer 5 for protecting the catalyst layer is provided on the electrolyte membrane to totally cover the electrolyte membrane 1 together with the diffusion layers. The cathode diffusion layers 221 to 226 are exposed on the membrane electrode assembly 4 surface. The anode side has a similar structure, although not shown. In the MEA of Example 5, the catalyst layer protrudes beyond the diffusion layer, with the catalyst layer ends covered with the adhesive layer 5, to relax stress concentration at the catalyst layer ends and preventing damage of the electrolyte membrane.

### EXAMPLE 6

FIG. 6 is a cross-sectional view illustrating an embodiment of fuel cell of the present invention, comprising a membrane electrode assembly, gaskets and power-collecting plates. Each of the cathode diffusion layer 22 and anode diffusion layer 32 has a smaller area than the respective catalyst layer, and is provided inside of the catalyst layer. The outermost periphery of the cathode catalyst layer 21 protrudes beyond the outermost periphery of the cathode side gasket 23, and so does the outermost periphery of the anode catalyst layer 31 beyond the outermost periphery of the anode side gasket 33. This structure prevents the electrolyte membrane 1 from directly coming into contact with a fuel, thereby preventing its deterioration. It also relaxes stress concentration at the catalyst layer end. As a result, it can extend service life of the fuel cell at least 1.7 times as an example, where the service life is defined as time required for the initial cell output to declines to 90%. The life can be extended whether the cell is fueled by a hydrogen gas or aqueous methanol solution. Example 6 used a gasket integrated with the cathode side power-collecting plate 24 having the cathode side air holes 25, or the anode side power-collecting plate 34 having the anode side air holes 35. However, it may be replaced by an O ring or the like which can seal a fuel.

The fuel cell of Example 6 may include a membrane electrode assembly of the structure illustrated in FIG. 3. For example, direct contact of a fuel with the electrolyte membrane can be prevented by providing the adhesive layer 5 for protecting the catalyst layer in such a way that its outermost periphery protrudes beyond the outermost periphery of each of the cathode side and anode side gaskets. This structure brings the effects similar to those of the fuel cell of Example 6 to relax stress concentration at the catalyst layer end.

It should be further understood by those skilled in the art that although the foregoing description has been made on embodiments of the invention, the invention is not limited thereto and various changes and modifications may be made without departing from the spirit of the invention and the scope of the appended claims.

1. A fuel cell equipped with a membrane electrode assembly comprising an electrolyte membrane coated with an anode catalyst layer and an anode diffusion layer on one side of the electrolyte membrane and with a cathode catalyst layer and a cathode diffusion layer on the other side of the electrolyte membrane, wherein the anode catalyst layer and the cathode catalyst layer have the same or essentially the same size and are set out at the same or essentially the same positions across the electrolyte membrane, and at least one of the anode diffusion layer and the cathode diffusion layer protrude at least at one end beyond the anode or cathode catalyst layer with which it comes into contact.

2. The fuel cell according to claim 1, wherein the anode catalyst layer and the cathode catalyst layer are set out at the same positions across the electrolyte membrane, and at least one of the anode diffusion layer and the cathode diffusion layer is set out in such a way not to totally overlap the anode or cathode catalyst layer with which it comes into contact.

3. The fuel cell according to claim 1, wherein the anode diffusion layer is larger than the anode catalyst layer and an end of the anode diffusion layer protrudes beyond the anode catalyst layer.

4. The fuel cell according to claim 3, wherein the anode diffusion layer protrudes beyond the anode catalyst layer by 100 to 300 μm, inclusive.

5. The fuel cell according to claim 1, wherein the anode diffusion layer is smaller than the anode catalyst layer to be set out inside of the anode catalyst layer.

6. The fuel cell according to claim 5, wherein the anode diffusion layer end is apart from the anode catalyst layer end by 100 to 300 μm, inclusive.

7. The fuel cell according to claim 1, wherein the cathode diffusion layer is larger than the cathode catalyst layer and an end of the cathode diffusion layer protrudes beyond the cathode catalyst layer.

8. The fuel cell according to claim 7, wherein the cathode diffusion layer protrudes beyond the cathode catalyst layer by 100 to 300 μm, inclusive.

9. The fuel cell according to claim 1, wherein the cathode diffusion layer is smaller than the cathode catalyst layer to be set out inside of the cathode catalyst layer.

10. The fuel cell according to claim 9, wherein the cathode diffusion layer end is apart from the cathode catalyst layer end by 100 to 300 μm, inclusive.

11. The fuel cell according to claim 1, wherein each of the anode diffusion layer and the cathode diffusion layer is smaller than the respective anode catalyst layer and cathode catalyst layer to be set out inside of the respective anode catalyst layer and cathode catalyst layer.

12. The fuel cell according to claim 1, wherein each of the anode diffusion layer and the cathode diffusion layer is larger than the respective anode catalyst layer and cathode catalyst layer to protrude beyond the respective anode catalyst layer and cathode catalyst layer.

13. The fuel cell according to claim 1, wherein the cathode diffusion layer is laid on the cathode catalyst layer of rectangular shape and essentially the same size, and has the corners cut off, to be out of alignment with the cathode catalyst layer by the cut off corners and partly expose the cathode catalyst layer.

14. The fuel cell according to claim 1, wherein the anode diffusion layer is laid on the anode catalyst layer of rectangular shape and essentially the same size, and has the corners cut off, to be out of alignment with the anode catalyst layer by the cut off corners and partly expose the anode catalyst layer.

15. A fuel cell equipped with a membrane electrode assembly comprising an electrolyte membrane coated with an anode catalyst layer and anode diffusion layer on one side and with a cathode catalyst layer and cathode diffusion layer on the other side, wherein the anode and cathode catalyst layers have the same or essentially the same area and are set out at the same or essentially the same positions across the electrolyte membrane, at least one of the anode and cathode diffusion layers protruding at least at one end beyond the corresponding electrode catalyst layer, and an adhesive layer for protecting the catalyst layer is provided between the protruded portion and electrolyte membrane.

16. The fuel cell according to claim 15, wherein the adhesive layer for protecting the catalyst layer is made of a material selected from the group consisting of a material having the same composition as a binder used for producing the membrane electrode assembly, epoxy resin, hydrocarbon-based resin, silicone-based resin and UV-curable resin.

17. A fuel cell equipped with a membrane electrode assembly comprising an electrolyte membrane coated with an anode catalyst layer and an anode diffusion layer on one side of the electrolyte membrane and with a cathode catalyst layer and a cathode diffusion layer on the other side of the electrolyte membrane, and also equipped with a gasket for tightly sealing a gas supplied as a fuel or oxidant to the membrane electrode assembly, wherein the anode catalyst layer and the cathode catalyst layer have the same or essentially the same size and are set out at the same or essentially the same positions across the electrolyte membrane, at least one of the anode diffusion layer and the cathode diffusion layer being out of alignment, at least at one end, with the cathode catalyst layer or anode catalyst layer end, and the end of the catalyst layer for the membrane electrode assembly is positioned on the outer side of the outer periphery of the gasket.
